(19) United States
(12) Patent Application Publication
(10) Pub. No.: US 2008/0267056 A1
(43) Pub. Date: Oct. 30, 2008

(54) METHOD AND APPARATUS FOR PERFORMING MULTI-ANTENNA TRANSMISSION

(75) Inventors: Farshid Aryanfar, Lake Zurich, IL (US); Nicholas E. Buris, Deer Park, IL (US); Frederick W. Vook, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/740,455

(22) Filed: Apr. 26, 2007

(51) Int. Cl. H04B 17/00

(52) U.S. Cl. 370/203; 455/67.11; 375/260

(57) ABSTRACT

A method and apparatus for performing beamforming are provided herein. During operation, a mobile device will notify a base station of the situation in which one or more of its antennas has become unusable. Using this technique, the Multiple Input, Multiple Output (MIMO) algorithms employed at the base station will be adjusted accordingly.

### FIELD OF THE INVENTION

The present invention relates generally to beamforming and in particular, to a method and apparatus for performing beamforming when an antenna's performance is compromised.

### BACKGROUND OF THE INVENTION

Transmit beamforming (sometimes referred to as transmit adaptive array (TXAA) transmission) increases the effective signal-to-noise ratio seen by a receiver device by creating a coverage pattern that tends to be directional in nature (i.e., not uniformly broadcast). This is accomplished by employing multiple antennas at the transmit site and weighting each antenna such that the combined transmissions result in a beamformed pattern having a maximum power in the direction of the receiver.

The premise of such beamforming is, in many cases, highly dependent on channel reciprocity. In particular, pilot symbols received (sounding data or sounding signals), for example on the uplink, are analyzed, and an assumption is made that the downlink channel behaves in a similar manner. The downlink channel is then weighted based on the received uplink pilot symbols. In many systems, the transmitting device requests uplink pilot symbols from each of the antennas on the receiving device prior to the time when the data will be transmitted to the receive device. These uplink pilot symbols enable the transmitting device to compute the transmit weights required to perform the transmit beamforming.

In a practical system, a condition may arise in which one of the antennas in the system (either at the transmit side or the receive side of the link) becomes incapable of satisfying its performance requirements. For example, if one of the antennas in an array is either blocked or detuned the result will be a poor link between that element and other antennas in the channel matrix. Current array reciprocity calibration techniques either do not account for the antennas (based on an assumption that the antennas are reciprocal) or can not separate the effects of the antennas from the transceiver hardware responses (as in an over-the-air calibration approach). As a result, existing calibration techniques are not capable of dealing with a blocked or detuned antenna at the transmit side, which may lead to the transmit algorithm either increasing the transmit power associated with the blocked antenna(s) to compensate for blockage or, if the power is fixed, sending the same power to these “bad” elements.

As another example, consider a time-division duplex (TDD) link that uses reciprocity-based transmit beamforming. If the blocked or detuned antenna is on the receive side of such a link, then it would be wasteful for the transmitting device to request uplink pilot symbols from a bad antenna. Doing so would not only waste downlink control channel resources to request the uplink pilot symbols, but it would also be a waste of the uplink resources that are allocated to the uplink pilots (sounding).

In either case, prior-art systems will continue to request pilot transmissions from the detuned or compromised antenna. These pilot transmissions reduce the efficiency of the device, and for any mobile device it is crucial to prevent such an event in order to achieve longer operation time. Therefore, a need exists for a method and apparatus for performing beamforming when an antenna is non-functional that increases the efficiency of the transmitting device.

### BRIEF DESCRIPTION OF THE DRAWINGS

FIG. 1 is a block diagram of a communication system.

FIG. 2 is a block diagram of a wireless device for use within the communication system of FIG. 1.

FIG. 3 is a flow chart showing operation of the wireless device of FIG. 2 during a first embodiment of the present invention.

FIG. 4 is a flow chart showing operation of the wireless device of FIG. 2 during a second embodiment of the present invention.

### DETAILED DESCRIPTION OF THE DRAWINGS

In order to address the above-mentioned need, a method and apparatus for performing multi-antenna transmission is provided herein. During operation, a node will notify a network element (e.g., a base station) of the situation in which one or more of its antennas has become unusable. Using this technique, the multi-antenna transmission algorithms (e.g., beamforming, Multiple Input Multiple Output (MIMO), Spatial Division Multiple Access (SDMA, and sometimes called collaborative MIMO or collaborative spatial multiplexing, or multi-user MIMO), transmit diversity, . . . , etc.) employed at the base station and the node will be adjusted accordingly and will operate as if the unusable antenna is no longer part of the communications link. Additionally, the notification that an antenna is bad on a particular node may cause the base station to respond by stopping any request for the mobile device to transmit sounding data on the bad antenna.

By not requesting transmit sounding data on bad antennas, the base station can reduce system interference. Additionally, since mobile devices will not be transmitting any pilot information over the bad antennas, a longer operation time can be achieved. Finally, because the base station knows of the bad antenna, it will use over the air recourses which in standard operation would have been assigned to the bad antenna for other users.

In the case where one of the base station antennas becomes unusable, the base station will inform the mobile devices of that fact, and the base stations will adjust its multiple antenna transmission techniques accordingly. For example, if a four transmit antenna base station has one transmit antenna become unusable, the base station may transmit a three-antenna pilot format on the downlink rather than a four-antenna pilot format. In this example, overall channel estimation performance is improved when a three-antenna pilot format is used and the mobile station exploits that fact compared to the case where a four antenna pilot format is transmitted when one of the transmit antennas is unusable.

Additionally, when the base station performs closed-loop multi-antenna transmission (e.g., beamforming, transmit spatial multiplexing, MIMO or transmit spatial division multiple access (SDMA)) based on codebook feedback from a mobile station, the mobile station may measure the downlink channel response and select one transmission vector or matrix from a list (or codebook) of possible transmission vectors/matrices. The mobile device then feeds back to the base station the index or identifier corresponding to the best transmission vector/matrix. The codebooks used in such systems may be designed and tailored for a specific number of base station transmit antennas. If one of the base station transmit antennas becomes unusable, the base station will inform the mobile stations that the codebook to be used is one tailored to the number of antennas equal to the number of usable base station transmit antennas. Improved overall performance will result when a codebook is used that is tailored to the actual number of usable transmit antennas.

Additionally, the link adaptation strategy may take into consideration the fact that one of the mobile station antennas has become unusable. The link adaptation strategy is the methodology used to establish the modulation and coding rate (or equivalently the overall data rate) to be used on a link. In the case of multi-antenna transmission or MIMO, the link adaptation strategy often also includes the additional step of selecting the specific multi-antenna transmission strategy (e.g., diversity transmission or space time coding, or spatial multiplexing, or beamforming). On the downlink for example, the mobile device may perform measurements of the base station signal strength relative to the interference and noise received on the downlink for the purpose of determining the proper modulation and coding rate and the transmission mode to be used on the downlink. The mobile station may then feed back a recommendation to the base station as to the proper modulation and coding rate and the transmission mode that should be used for data transmission. If the mobile device knows that one of its receive antennas has become unusable, then the mobile device will exclude the unusable antenna from the calculations that are performed to determine the proper modulation and coding rate and transmission mode to be used on the downlink.

In other cases, the base station may incorporate knowledge of the number of subscriber receive antennas into the link adaptation and transmission mode selection strategy. When one of the receive antennas on the mobile device becomes unusable, the base station will be informed of that fact and will adjust its link adaptation strategies for the downlink based on the actual number of usable receive antennas at the mobile device. The strategy of selecting the modulation and coding rate and multi-antenna transmission mode for the uplink may also be adapted to incorporate the fact that one or more the antennas at one or both ends of the link have become unusable.

The present invention encompasses a method for a first network element to notify a second network element of a bad antenna. The method comprises the steps of determining by the first network element if an antenna is bad, and notifying the second network element if it is determined that the antenna is bad. The notification causes the second network element to respond by adjusting a multi-antenna transmission algorithm employed at the first and the second network elements.

The present invention additionally encompasses a method for a mobile station to notify a base station of a bad antenna. The method comprises the steps of determining if an antenna is bad and notifying the base station if it is determined that the antenna is bad. The notification causes the base station to respond by stopping any request to transmit sounding data on the bad antenna.

The present invention additionally encompasses an apparatus comprising a plurality of antennas, antenna sensing circuitry determining if an antenna from the plurality of antennas is bad, and a transmitter notifying a network element if it is determined that the antenna is bad, causing the network element to respond by adjusting a multi-antenna transmission algorithm.

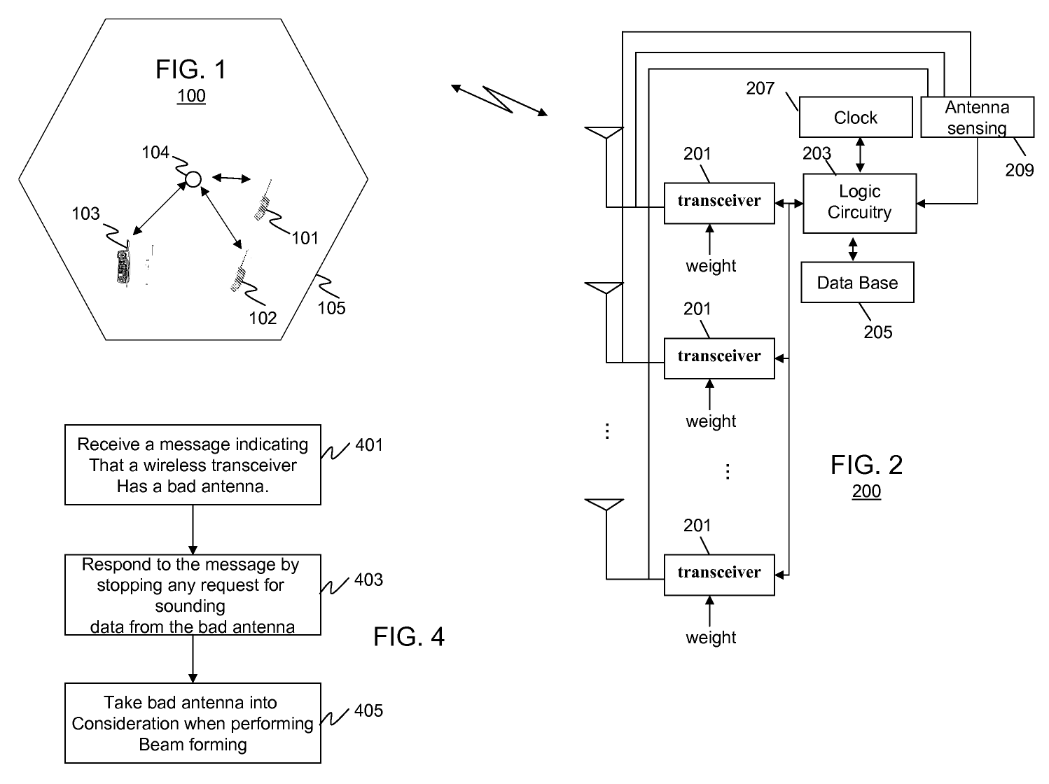

Turning now to the drawings, wherein like numerals designate like components, FIG. 1 is a block diagram of communication system 100. Communication system 100 comprises one or more cells 105 (only one shown) each having a base transceiver station (BTS, or base station) 104 in communication with a plurality of remote, or mobile units 101-103. Remote units 101-103 may also be referred to as communication units, User Equipment (UE), mobile devices, mobiles, or simply users, while base station 101 may also be referred to as a communication unit or simply Node-B. Communication system 100 preferably utilizes an Orthogonal Frequency Division Multiplexed (OFDM) or multi-carrier based architecture with beamforming. When using beamforming, base station 104 employs multiple antennas (not shown in FIG. 1) to transmit multiple data streams across one or more OFDM subcarriers to one or more receiving devices 101-103. Each antenna is weighted such that the combined transmissions result in a beamformed pattern having a maximum power in the direction of the receiver. Other transmission techniques can be used in addition to or instead of transmit beamforming.

As discussed above, if one of the antennas in an array is either blocked or detuned the result will be a poor link between that element and other antennas in the channel matrix. In either case, if the compromised antenna is on the receive side of the link, prior-art systems will continue to request pilot transmissions from the detuned antenna. These pilot transmissions reduce the efficiency of the mobile device and also result in inefficient usage of the over-the-air resources of the network.

In order to address this issue, a mobile device 101-103 will notify base station 104 of the situation in which one or more of its antennas have become unusable. Using this technique, the multi-antenna transmission (e.g., beamforming or MIMO) algorithms employed at base station 104 will be adjusted accordingly and will operate as if the unusable antenna is no longer part of the link. Additionally, for base stations employing uplink sounding signals the notification that an antenna is bad on a particular mobile device 101-103 will cause base station 104 to respond by stopping any requests for the mobile device to transmit sounding data on its bad antenna.

FIG. 2 is a block diagram of wireless device 200 for use in the communication system of FIG. 1. Wireless device 200 may function as base station 104, or any mobile unit 101-103. As shown, wireless device 200 comprises logic circuitry 203, database 205, and a plurality of transceivers 201. Database 205 preferably comprises storage means such as but not limited to hard disk storage, random access memory, etc. Transceivers 201 comprise both transmit and receive circuitry and are common circuitry known in the art for communication utilizing a well known communication protocols. In this particular embodiment of the present invention, transceivers 201 utilize the IEEE 802.16 communication system protocol.

Logic circuitry 203 preferably comprises a microprocessor controller such as, but not limited to a Freescale PowerPC microprocessor. Logic circuitry 203 serves as means for controlling wireless device 200, and as means for analyzing message content to determine any actions needed. Antenna sensing circuitry 209 serves as means for determining if any antenna has gone bad. Circuitry 209 may utilize any of several techniques for determining if an antenna has gone bad, several of which are now described.

A single antenna can be characterized, among other things, by its Input Impedance and how well this impedance is matched to the circuitry that the antenna is connected to. A measure of this match that can be measure directly is the so called Voltage Standing Wave Ratio (VSWR). Physically, this quantity pertains to two waves, traveling in opposite directions and interfering with each other forming an interference pattern. VSWR is the ratio of the maximum to the minimum value of the total field in the aforementioned interference pattern. For good performance, this VSWR, when measured at a reference plane between the antenna and the transceiver 201 which is connected to, has to be below a certain threshold.

In a first embodiment circuitry 209 monitors voltage standing wave ratio (VSWR) of the antennas directly by measuring reflected signal from the antenna using directional coupler. Circuitry 209 may comprise a directional coupler. When wireless device 200 is transmitting, a mismatch between a transceiver 201 and its antenna will result in a wave that is reflected from the antenna back into the transceiver. A directional coupler has the capability of detecting this reflected wave and when its power is compared to the forward traveling wave coming out of the transceiver, the VSWR can be directly computed. This comparison is made in the logic circuitry 203 which is also responsible for affecting the algorithmic changes claimed in the present invention as discussed below. Such a technique is described in US Patent Application No. US20070004344 A1, entitled WIRELESS DEVICE AND SYSTEM FOR DISCRIMINATING DIFFERENT OPERATING ENVIRONMENTS.

In another embodiment, circuitry 209 may simply monitor voltage standing wave ratio (VSWR) of the antenna indirectly by monitoring bias current of the power amplifier feeding the antenna, and in yet another embodiment, circuitry 209 may monitor the performance of an antenna by monitoring the output power of the power amplifier feeding the antenna.

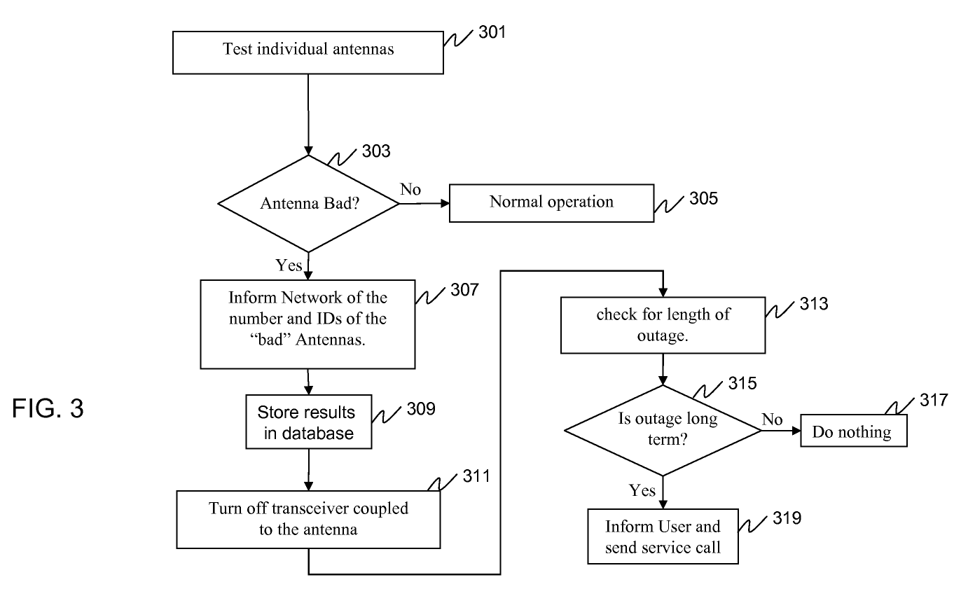

FIG. 3 is a flow chart showing the operation of the wireless device of FIG. 2 during a first embodiment of the present invention. In particular, the logic flow of FIG. 3 shows those steps taken when wireless device 200 acting as a network element detects that an antenna has gone bad. As mentioned above, device 200 may comprise a base station or a mobile unit.

The logic flow begins at step 301 where individual antennas are tested by the circuitry 209 as discussed above. At step 303, circuitry 209 determines if any antennas are bad. If so, the logic flow continues to step 307, otherwise the logic flow returns to step 305 where normal operation of device 200 takes place. At step 307 the logic circuitry 203 utilizes the good transceivers (i.e., transceivers connected to good antennas) to inform a network element (e.g., a base station or a mobile station) of the bad antenna(s) by providing the identification of the bad antenna(s). This is done via an over-the-air message.

As discussed above, if the notification is to a base station, the notification causes base station 104 to respond by stopping any request to transmit sounding data from the bad antenna(s). Additionally, the base station may respond by adjusting a multi-antenna transmission algorithm (e.g., beamforming algorithms, MIMO algorithms, SDMA algorithms, and transmit diversity algorithms employed at the first and the second network elements) employed at the base and the mobile. Examples of adjusting various transmission algorithms are described below:
beamforming algorithms: If a four transmit antenna base station has one transmit antenna become unusable, the base station would perform its beamforming operation only over the three usable antennas. In reciprocity based beamforming, the BS may disable the operation of or ignore the output from the uplink channel estimation algorithms on the unusable antenna. In the case where the BS uses codebook based beamforming, the BS would inform the mobile station that a three-antenna pilot format will be transmitted on the downlink rather than a four-antenna pilot format. The base station would also inform the mobile stations that the antenna array weight vector codebook would be a three transmit antenna codebook rather than a four transmit antenna codebook.
Open-Loop MIMO algorithms: If a four transmit antenna base station employs open-loop MIMO techniques and one transmit antenna become unusable, the base station would then transmit a three-antenna pilot format on the downlink rather than a four-antenna pilot format after informing the mobiles that a three-antenna pilot will henceforth be used. Furthermore, the base would use a three-antenna MIMO transmission scheme rather than a four antenna transmission scheme and will inform the SS that a three-antenna MIMO transmission scheme is being used. The mobile stations would then adjust their MIMO receiver processing algorithms to process the three-antenna MIMO transmission scheme rather than the four-antenna MIMO scheme.
Closed-Loop MIMO algorithms on the downlink: In the case of codebook-based closed-loop MIMO, if one of the four base station antennas becomes unusable, the base station would (similar to the beamforming example given above) inform the mobile station that three-antenna pilot formats and three-antenna codebooks would be used in the closed-loop MIMO scheme.
Receive SDMA algorithms on the uplink: If a two antenna base station has one receive antenna become unusable, the base station will stop assigning uplink SDMA allocations because spatially multiplexing two users is generally not beneficial with only one receive antenna at the base station. Furthermore, if a receive antenna at the base station becomes unusable, the base station will remove that antenna from any of the processing computations needed to receive and decode the signal from the multiple SDMA users on the uplink. The removal from the processing computations can include disabling any channel estimators that operate on the unusable antenna or discarding any signals received from the unusable antenna or any combination thereof.
Transmit SDMA algorithms on the downlink: Similarly, for transmit downlink SDMA, the base station's unusable antenna is excluded from the SDMA transmissions scheme. For example, if codebook-based transmit SDMA algorithms are used and a four antenna base station has one antenna become unusable, then (similar to the beamforming example above) the base station would inform the mobile station that three-antenna pilot formats and three-antenna codebooks would be used in the transmit SDMA scheme. For non-codebook methods, the transmit weights for transmit SDMA will be computed without taking into account the unusable antenna. For example in transmit SDMA schemes that exploit uplink information to compute the transmit weights, the signals received on the unusable antenna will be discarded or ignored, and any algorithms that process the uplink signals will disregard any signals received on the unusable antenna. The unusable antenna will also be not included in any calculations of the downlink transmit weights.
transmit diversity algorithms: If a four transmit antenna base station has one transmit antenna become unusable, the base station may transmit a three-antenna pilot format on the downlink rather than a four-antenna pilot format. Furthermore, the base would use a three-antenna MIMO or diversity transmission scheme rather than a four antenna transmission scheme and will inform the SS that a three-antenna MIMO or diversity transmission scheme is being used.

The above examples are given in the context of base station with some number of antennas. It should be obvious that these examples can easily be extended to base stations with a number of antennas that differs from the numbers used in these examples. It should also be obvious that examples provided in the context of an uplink can easily be extended to the downlink context. Similarly, it should be obvious that examples provided in the context of an downlink can easily be extended to the uplink context. Similarly, it should be obvious that the examples provided can be easily extended to the situation where the roles of the base station and mobile station are reversed from those given in the examples. The common feature in the above examples is the step of making it known to the network elements that an antenna in the system has become unusable so that any processing algorithms that incorporate the unusable operation will know to remove that antenna from any transmit or receive processing schemes being used by the system. As a result, this common feature can be applied to any current or yet-to-be-developed multi-antenna transmission/reception scheme.

Continuing with the logic flow of FIG. 3, at step 309 the logic circuitry 203 accesses the database 205 and clock 207 and stores an identification of the bad antenna(s) in database 205 along with a time stamp indicating when the antenna(s) was detected as being bad. The particular transceiver 201 attached to the bad antenna(s) is then shut down (step 311) by logic circuitry 203. Other system parameters may be adjusted at step 311. For example, if device 200 is acting as a base station, step 311 may optionally include adjusting a multi-antenna transmission algorithm employed for communications. Also, as mentioned above, if device 200 is acting as a mobile unit, the mobile unit at step 311 may change a codebook used for feeding back to the base station the index or identifier corresponding to the best transmission vector/matrix. Finally, at step 311 the link adaptation strategy (e.g., a modulation and coding scheme utilized by the base and the mobile) may take into consideration the fact that one of the mobile station antennas has become unusable. For example, the link adaptation algorithm must determine the optimal data rate to use over a link based on the various characteristics of the link. Generally the selection of the data rate for a link involves choosing the best modulation and coding strategies (MCS) to use over the link. The MCS consists of a modulation (e.g., QPSK, 16-QAM, 64-QAM, etc.) and a coding rate (e.g., ⅓, ½, etc.). Often the link adaptation strategy is based on an estimate of multi-antenna channel response between the transmitter and receiver. If an antenna on either the transmit or the receive side of the link has become unusable, then the method whereby the best MCS is chosen will remove the unusable antenna from any computations needed to select the best MCS. This removal operation can be in the form of disabling any channel estimators that operate on the unusable antenna, ignoring any signals received on the unusable antenna, disabling the processing of any signals received on the unusable antenna, or any combination thereof. In spatial multiplexing systems such as MIMO or SDMA, the link adaptation algorithm generally also involves the selection of the level of spatial multiplexing that can be supported by the link. For example, in MIMO systems, the link adaptation algorithm must choose not only the MCS level, but also the MIMO transmission mode or the number of spatially multiplexed data streams to transmit. For MIMO transmission, the “spatial multiplexing mode” refers to the spatial rate of the MIMO transmission scheme, and is often described in terms of the number of spatial data streams transmitted on the same time-frequency resources. For example, in IEEE 802.16e the link adaptation algorithm for open-loop MIMO would have to choose between Matrix A transmission (equivalent to the well-known Alamouti transmission scheme) and Matrix B transmission (open-loop spatial multiplexing MIMO. In SDMA schemes the link adaptation algorithm must chose which mobile stations should be multiplexed together onto the same time-frequency resources. (The link adaptation schemes for SDMA must also determine whether multiplexing multiple users onto the same time-frequency resources should be performed at all.) For SDMA transmission, the “spatial multiplexing mode” refers to the number of mobile stations that are multiplexed on the same time-frequency resources. The link adaptation algorithms for these various cases and schemes generally operate based on an estimate of the multi-antenna channel response in the system. If one of the base station antennas becomes unusable, any channel estimation algorithm that is used by the link adaptation algorithm and that operates on the unusable antenna may be disabled or have its outputs ignored if it is not disabled. Any other processing algorithm that operates on the multi-antenna channel response for the purposes of link adaptation (or for the purposes of multi-antenna transmission or reception) should either have its output ignored or discarded or should have its functionality completely disabled or partially disabled depending on the implementation.

Continuing, the length of the outage is then determined by logic circuitry 203 by accessing database 205 and determining if the particular antenna(s) have been identified as bad in the recent past (step 313). At step 315 it is determined if the outage is long term, and if so the logic flow continues to step 319 where the user and the network operator are informed via the good transceivers transmitting an over-the-air message. If the outage is not long-term, the logic flow ends at step 317.

At step 319, the user of the device may be informed via a display (not shown in FIG. 2). A service call may be initiated by the device automatically to the carrier (network administrator). In the event the antenna could be easily replaced by the user, the network administrator may select to send a new antenna part to the customer with replacement instructions. Alternatively, the network administrator may contact the user with an invitation for a product drop-off for appropriate repairs.

It should be noted that the above logic flow may be performed by wireless device 200 on a scheduled basis. Thus, each antenna may be tested over and over on a scheduled basis, for example, every t₁ seconds. If a particular antenna has been found “bad” more than N₁ times within a period of time, T₁, the time interval between two consecutive antenna tests may be increased (e.g., increases to t₂). If an outage has been detected more than N₂ times within T₂ period of time, the outage may be considered long-term.

The parameters t₁ and t₂ can be adjusted for best system performance for a given application and for a given network. For example, for cell phones they can be of the order of millisecond and seconds respectively. Similarly, N₁ and N₂ are also adjustable and can be in the tens and hundreds of milliseconds, respectively. Also, the values of t₁ and t₂ can be different depending on whether the antenna has just been removed from the system versus when the antenna is a candidate for being returned to the system, or other parameters deemed important by the network operator at the time.

As discussed above, because base station 104 will not request the transmission of sounding data from the bad antenna(s), system interference can be reduced. Additionally, since devices will not be transmitting any pilot information over the bad antennas, a longer operation time can be achieved. Finally, because the base station knows of the bad antenna, the base station can advantageously adjust the transmit weights accordingly as if the bad antenna were not present in the link. As is known in the art, the optimal transmit weights depend on the channel between each transmit antenna and each receive antenna. If one of the receive antennas on a mobile device is bad, then the usual channel estimation algorithm employed by the base station would very likely produce a completely erroneous estimate of the channel response to that receive antenna. Incorporating that erroneous channel estimate into the calculation of the transmit beamforming weights will degrade beamforming performance.

FIG. 4 is a flow chart showing operation of the wireless device of FIG. 2 during a second embodiment of the present invention. In particular, the logic flow of FIG. 4 shows the steps taken by wireless device 200 when acting as a base station that determines a mobile device has a bad antenna(s). The logic flow begins at step 401 where transceivers 201 receive a message indicating that a mobile device has a bad antenna. The logic flow continues to step 403 where logic circuitry 203 responds by stopping any request for sounding data from the bad antenna on the mobile device. Finally, at step 405, logic circuitry 204 takes the bad antenna into consideration when performing beamforming. More particularly, the algorithm for computing the transmit beamforming weights incorporates the channel knowledge from the usable antennas on the mobile device and disables the incorporation of any channel information from the bad antenna into the calculation.

While the invention has been particularly shown and described with reference to a particular embodiment, it will be understood by those skilled in the art that various changes in form and details may be made therein without departing from the spirit and scope of the invention. For example, while the above description was given for a mobile unit that detects that an antenna has gone bad, one or ordinary skill in the art will recognize that a base station may employ the same techniques when the base station perceives that an antenna has gone bad. It is intended that such changes come within the scope of the following claims.

1. A method for a first network element to notify a second network element of a bad antenna, the method comprising the steps of:
determining by the first network element if an antenna is bad; and
notifying the second network element if it is determined that the antenna is bad, causing the second network element to respond by adjusting a multi-antenna transmission algorithm employed at the first and the second network elements.

2. The method of claim 1 wherein the first network element comprises a base station and the second network element comprises a mobile station.

3. The method of claim 1 wherein the first network element comprises a mobile station and the second network element comprises a base station.

4. The method of claim 1 wherein the notification additionally causes the second network element to stop any request to transmit sounding data on the bad antenna.

5. The method of claim 1 wherein the multi-antenna transmission algorithm comprises algorithms taken from a group consisting of beamforming algorithms, MIMO algorithms, SDMA algorithms, and transmit diversity algorithms employed at the first and the second network elements.

6. The method of claim 1 wherein the step of notifying comprises the step of notifying via an over-the-air message.

7. The method of claim 1 wherein the determination of the bad antenna causes a modulation and coding scheme utilized by first and the second network elements to be changed.

8. The method of claim 1 wherein the determination of the bad antenna causes the first network element to change a pilot format on a downlink transmission.

9. The method of claim 1 wherein the notification causes the second network element to respond by changing a codebook used for feedback.

10. The method of claim 1 further comprising the step of:
transmitting a service request based on the determination.

11. The method of claim 1 wherein the step of determining the antenna is bad comprises the step of determining the antenna is bad based on a Voltage Standing Wave Ratio (VSWR).

12. The method of claim 1 wherein the multi-antenna transmission algorithm is adjusted by adjusting a spatial multiplexing mode utilized by the first and second network elements.

13. A method for a mobile station to notify a base station of a bad antenna, the method comprising the steps of:
determining if an antenna is bad; and
notifying the base station if it is determined that the antenna is bad, causing the base station to respond by stopping any request to transmit sounding data on the bad antenna.

14. The method of claim 13 wherein the base station employs a multi-antenna transmission algorithm comprising algorithms taken from a group consisting of beamforming algorithms, MIMO algorithms, SDMA algorithms, and transmit diversity algorithms employed at the base station and the mobile station.

15. The method of claim 13 wherein the step of notifying comprises the step of notifying via an over-the-air message.

16. The method of claim 15 wherein the message also causes the base station to change a modulation and coding scheme utilized by the base station and the mobile station.

17. The method of claim 13 wherein the step of determining the antenna is bad comprises the step of determining the antenna is bad based on a Voltage Standing Wave Ratio (VSWR).

18. An apparatus comprising:
a plurality of antennas;
antenna sensing circuitry determining if an antenna from the plurality of antennas is bad; and
a transmitter notifying a network element if it is determined that the antenna is bad, causing the network element to respond by adjusting a multi-antenna transmission algorithm.

19. The apparatus of claim 18 wherein the network element comprises a base station.

20. The apparatus of claim 18 wherein the notification additionally causes the network element to stop any request to transmit sounding data on the bad antenna.
